(19) United States
(12) Patent Application Publication
(10) Pub. No.: US 2018/0137480 A1
(43) Pub. Date: May 17, 2018

(54) MOBILE DEVICE GESTURE AND PROXIMITY COMMUNICATION

(71) Applicant: Honey Inc., Menlo Park, CA (US)

(72) Inventors: Frank Pierce Houghton, IV, San Carlos, CA (US); Hans Peter Melerski, La Jolla, CA (US); Charles Francis Buck, Kempton, PA (US)

(21) Appl. No.: 15/809,890

(22) Filed: Nov. 10, 2017

Related U.S. Application Data
(60) Provisional application No. 62/421,133, filed on Nov. 11, 2016.

(51) Int. Cl. G06Q 20/08; H04W 4/02; H04W 4/00; G01S 19/01; G06F 3/01; G06Q 20/32

(52) U.S. Cl. CPC G06Q 20/08; H04W 4/02; H04W 4/005; H04L 67/025; G06F 3/017; G06Q 20/3276; G01S 19/01

(57) ABSTRACT

A transaction service and associated mobile application are described that enables users to communicate with mobile devices in a local area. Communications may cause the transfer of money from the owner of a first device to the owner of a second device. User interaction to cause the transfer includes gesture based controls, QR code scanning, and privacy screens.

### CROSS-REFERENCE TO RELATED APPLICATION(S)

This application claims priority to U.S. Provisional Patent Application No. 62/421,133 filed on Nov. 11, 2016 and entitled, “MOBILE DEVICE GESTURE AND PROXIMITY COMMUNICATION,” which is hereby incorporated by reference in its entirety. This application is therefore entitled to a priority date of Nov. 11, 2016.

### TECHNICAL FIELD

Teachings relate broadly to mobile applications (“Apps”) and more particularly to Apps capable of interacting with a matching App in close proximity coordinated by an internet based web-service, cloud computing micro-service, or cellular network embedded digital processing system.

### BACKGROUND

Modern mobile communication devices, such as smartphones (or mobile phones) can communicate over multiple communications links such as mobile networks, Wi-Fi, Near Field Communication (NFC) links, Bluetooth, and wired communications links (e.g., USB). This enables users of such mobile communications devices to interact with one another. Many mobile communication devices are equipped with a number of functions including: processors for processing information; a screen for displaying information to the user; and one or more buttons for making inputs. Alternatively, inputs may be made via a touchscreen; a camera for capturing visual information or data (such as Quick Response (QR) codes); accelerometers, for detecting motion(s); and a mechanism (such as an off-balance motor) for vibrating the phone (providing haptic feedback to the user).

### BRIEF DESCRIPTION OF THE DRAWINGS

FIG. 1 is a diagram of an example networked computing environment;

FIG. 2A is a block diagram of an example architecture of a transaction service associated with the networked computing environment of FIG. 1;

FIG. 2B is a block diagram of an example architecture of a mobile communications device associated with the networked computing environment of FIG. 1;

FIG. 3 is a flowchart of an example process for gesture-based transaction between mobile devices in proximity to each other;

FIGS. 4A-4B shows a sequence of screen captures of a graphical user interface (GUI) associated with the process of FIG. 3;

FIG. 5 is a flowchart of an example process for performing a transaction between users using a one-sided application;

FIG. 6 shows a sequence of screen captures of a GUI associated with the process of FIG. 5;

FIG. 7 is a flowchart of an example process for fulfilling cash requests between users; and

FIG. 8 is a block diagram illustrating an example of a processing system in which at least some operations described herein can be implemented.

### DETAILED DESCRIPTION

### Overview

A technique is introduced for processing transactions between users of mobile communications devices without requiring the users to exchange personally identifiable information (PII). A mobile application (or “App”) can be installed on mobile communication devices such as smart phones to facilitate communication with a remote transaction service for processing such transactions. Generally, the mobile application may enable the moving or exchanging of money between users of the mobile communications devices through what is referred to as machine-to-machine (or “M2M”) transactions. The users may be referred to collectively as “transactors” or individually as “senders” or “receivers” depending on the side of the transaction. M2M transactions may occur between users having mobile communications devices that are in proximity to each other. The introduced technique provides an effective way for users to transfer value (e.g., funds, credits, points, etc.) on the spot without using cash and without exchanging PII such as phone numbers, email addresses, user names, account information, etc. By not requiring an exchange of PII, the disclosed technique both streamlines on-the-spot transactions between users as well as preserves the privacy of the users. The introduced technique can be utilized to facilitate various types of on-the-spot transactions between users such as a product purchases, bill payments, tipping, currency conversion, charge splitting, charitable donations, cash fulfillment, and the like.

### Example Networked Computing Environment

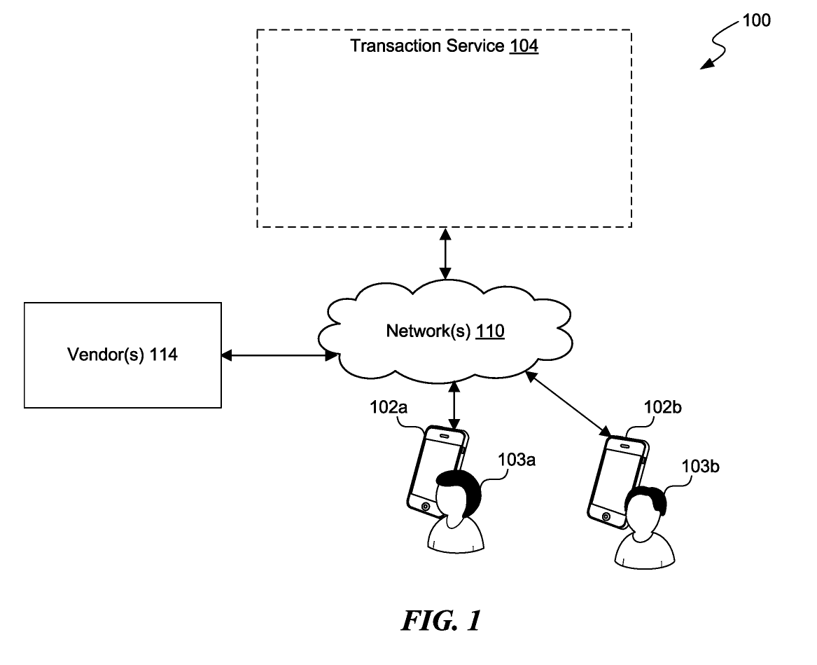

FIG. 1 is a diagram of an example networked computing environment 100 in which the disclosed technique may be used. As shown in FIG. 1, the networked computing environment 100 includes a transaction service 104, one or more vendors 114, and one or more users 103a-b with associated devices (e.g., mobile communications devices) 102a-b. A “user” in this context may refer to any person or entity (including artificial entities) that utilizes the functionalities of the transaction service 104. Entities (e.g., devices, users, software, etc.) associated with the aforementioned components of networked computing environment 100 may be communicatively coupled via one or more communications channels, for instance communications networks 110 (e.g., LAN, WAN, Internet, Worldwide Web, cellular network, USB®, Bluetooth®, Wi-Fi®, NFC, etc.). In the example embodiment shown in FIG. 1, users 103a-b and/or vendors 114 may access the transaction service 104 using network connected devices such as the mobile communications devices 102a-b. In some embodiments, access to the one or more networks 110 is via an internet service provider (ISP), mobile service provider, satellite service provider, and the like.

The transaction service 104 may represent any combination of hardware and or/software for executing instructions to carry out the functionalities described herein. For example, the transaction service 104 may be implemented using one or more network connected server computer device (physical or virtual) with associated non-transitory processor-readable storage media or other data storage facilities. Instructions for carrying out certain processes described herein may be implemented as software instantiated in a computer-readable medium or computer-readable storage medium on a machine, in firmware, in hardware, in a combination thereof, or in any applicable known or convenient device or system. This and other modules, submodules, or engines described in this specification are intended to include any machine, manufacture, or composition of matter capable of carrying out at least some of the functionality described implicitly, explicitly, or inherently in this specification, and/or carrying out equivalent functionality.

In some embodiments, the transaction service 104 comprises an internet-based web service and/or a cloud-computing micro service. For example, transaction service 104 may be implemented (at least partially) in instructions executed by computing entities in a cloud-computing environment. Such a cloud-computing environment may be hosted by a third-party cloud-computing provider. For example, Amazon® offers cloud computing services as part of the Amazon Web Services (AWS) platform. One or more of the functionalities of the transaction service 104 may be implemented using products and services associated with a cloud-computing platform such as Amazon® AWS. In an illustrative embodiment, computing functionality is provided using virtual computing entities (e.g., Amazon® EC2 virtual server instances and or Lambda event-based computing instances) executing across one or more physical computing devices and storage functionality is provided using scalable cloud-based storage (e.g., Amazon® S3 storage) and/or managed databases, data warehouses, etc. (e.g., Amazon® Aurora, DynamoDB, Redshift, Spanner, etc.).

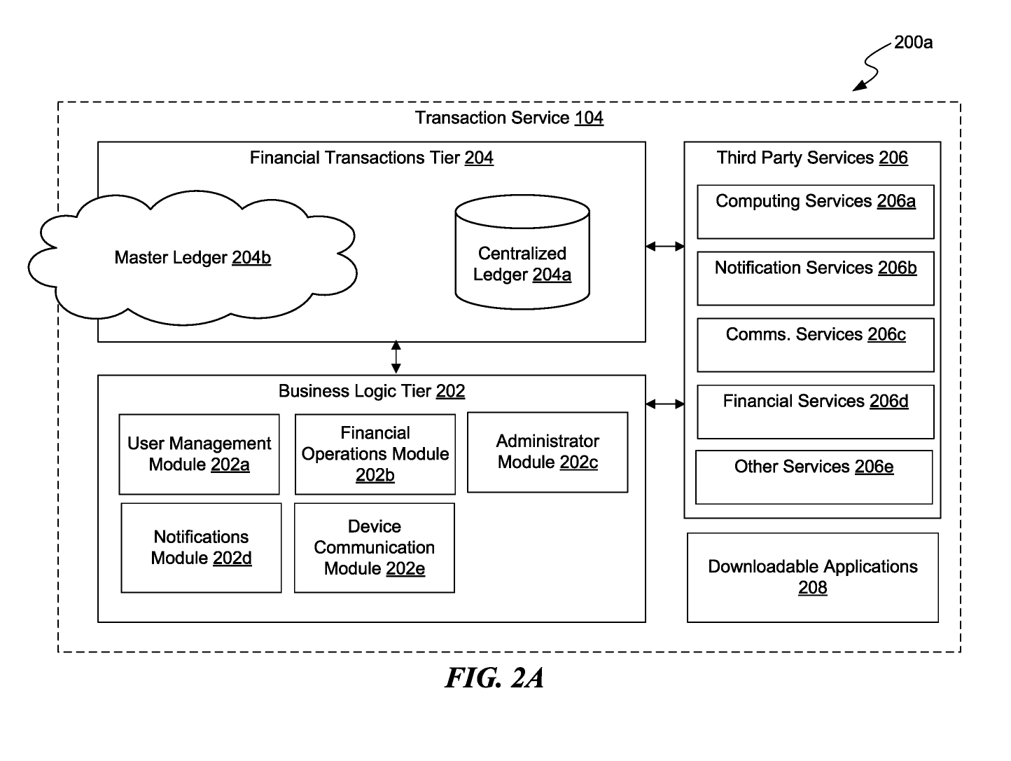

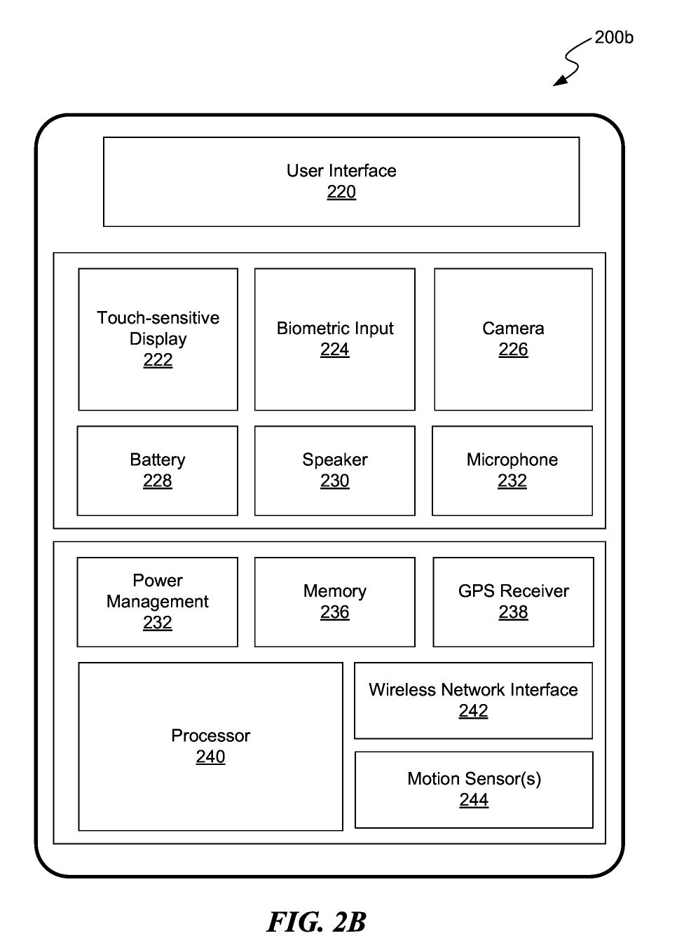

FIG. 2A shows a block diagram of an example architecture 200a of the transaction service 104 described with respect to FIG. 1. As shown in FIG. 2A, the transaction service can include multiple logical components such as a business logic tier 202, a financial transaction tier 204, and integration with one or more third-party services 206. It shall be appreciated that the architecture 200a depicted in FIG. 2A is provided for illustrative purposes and is not to be construed as limiting. Other embodiments may include more or fewer components than are shown in FIG. 2A or may organize certain components differently.

The business logic tier 202 may include one or more modules 202a-e for handling certain aspects of a transaction service in accordance with the present disclosure.

A user management module 202a may be implemented to manage information associated with the one or more users 103a-b and vendors 114 (e.g., user identifiers, user accounts, user contact information, user device information, etc.) that access the transaction service 104.

A financial operations module 202b may manage financial information associated with the various users (e.g., credit and/or debit account numbers, bank account numbers, expiration dates, security codes, etc.) and may interface with a financial transactions tier 204, for example, for processing transactions between users, and/or one or more external financial services 206d for managing ingress and egress of funds to user accounts associated with the transaction service 104. For example, a user can add funds to a user account associated with the transaction service 104 (“ingress”) by drawing funds from an external account (e.g., a credit account, debit account, bank account, merchant account, etc.). Similarly, a user may extract funds from a user account associated with the transaction service 104 (“egress”) by transferring the funds to an external account (e.g., a credit account, debit account, bank account, merchant account, etc.). A user may also add or withdraw funds from other sources, such as another user, a retailer, a bank or other partner. Note that the term “funds” is used in the above example for illustrative clarity, however transactions may involve the transfer of other types of value such as credits, points, rewards, title, etc.

An administrator module 202c may provide administrator features allowing an administrator user associated with a provider of the transaction service 104 to monitor, manage, and/or configure certain aspects of the services provided to users 103a-b and vendors 114.

A notifications module 202d may handle transmission of notifications to user devices 102a-b, for example, in conjunction with a third-party notification service 206b such as a Google or Apple push service.

A device communication module 202e may handle communications, over network 110, between the transaction service and the one or more devices associated with users 103a-b and/or vendors 114 (e.g., devices 102a-b).

A financial transactions tier 204 may include the infrastructure to handle processing of transactions in accordance with the disclosed technique. For example, in some embodiments, processing transactions may include updating one or more ledgers associated with the parties to the transaction. A ledger in this context may include a centralized ledger 204a (e.g., a database of transaction information) associated with and managed by the transaction service 104, a centralized ledger associated with a third-party financial entity such as a bank, or a master ledger 204b stored in a distributed database system such as a blockchain.

The transaction service 104 may implement, integrate with, communicate with, or otherwise utilize one or more third-party services 206 such as third-party computing services (e.g., Amazon® AWS), notification services 206b (e.g., Apple® push), communications services (e.g., for email or SMS messaging), financial services 206d (e.g., offered by banks credit card issuers, etc.), and any other third-party services 206e. Interface with the one or more third-party services 206 may be via one or more application program interfaces (APIs).

The remote service 104 may also include or be associated with one or more applications 208 (or “Apps”) that are downloadable to the user devices 102a-b. In some embodiments, certain functionalities associated with the described technique may require communication between the remote transaction service 104 and a downloaded application installed at a device 102a-b. In some embodiments, the applications 208 are implemented as “thin clients” at the one or more devices 102a-b meaning that the majority of the processing associated with certain functions is performed at remote computing devices associated with the transaction service 104 instead of locally by the application installed at a user device 102a-b. The application 208 may be platform agnostic, working with various platforms (e.g., Android, iOS, etc.) and/or software (e.g., operating systems such as Android, iOS or Microsoft Windows). In other words, applications 208 in conjunction with the transaction service 104 may facilitate M2M proximity payments across various platforms (e.g., Andoid, iOS, etc.).

### Example Mobile Communications Device

FIG. 2B is a block diagram of an example architecture of a mobile communication device 200b which may be utilized with the present innovation. The mobile communication device 200b shown in FIG. 2B may be the same as the devices 102a-b associated with users 103a-b. The mobile communication device 200a may comprise a user interface 220 (e.g., a graphical user interface (GUI)), a touch-sensitive display 222, a biometric input device 224 (e.g., fingerprint sensor, retinal scanner, voice print identification module, etc.), a camera 226, a battery 228, a speaker 230, a microphone 232, a power management component 234, a memory 236, a GPS receiver 238, a processor 240 (e.g., including a central processing unit (CPU) and/or graphical processing unit (GPU), a wireless network interface 242 (e.g., including an RF transceiver and any components associated with Wi-Fi, Bluetooth, NFC, or any other wireless communication standard), and one or more motion sensors 244 (e.g., accelerometers). Those skilled in the pertinent art will recognize that other components (such as a vibrating mechanism) that are not shown in FIG. 2B may be present in a mobile communication device. A resident mobile application (e.g., application 208 downloaded from a remote application store such as the Apple® App Store may be stored in a memory 236 of the mobile communication device 200b as a set of instructions which when executed by the processing 204 cause the mobile communication device 200b to perform certain functions. The memory 236 and processor 240 may interface with other components such as the GPS receiver 238 (to determine a location of the mobile communication device 200b), the motion sensors 244 (for sensing movement of the mobile communication device 200b), the wireless network interface 242 (for communicating with external devices via one or more networks 110), the touch sensitive display 222 (for providing visual output and receiving user inputs, for example, as part of a GUI), a camera 226 (for capturing images), a microphone 232 (for capturing audio), a speaker 230 (for providing audible outputs), and a biometric input device 224 (for receiving biometric inputs, for example, to authenticate an identity of a user).

A mobile communications device 200b in this context can include any type of device capable of communication over one or more communications links (e.g., computer network 110). Example devices include a laptop computer, tablet computers (e.g., Apple iPad™), mobile phones (e.g., Apple iPhone™), wearable devices (e.g., Apple Watch™) augmented reality devices (e.g., Google Glass™), virtual reality devices (e.g., Oculus Rift), and the like.

### Gesture-Based Transaction Between Mobile Communications Devices

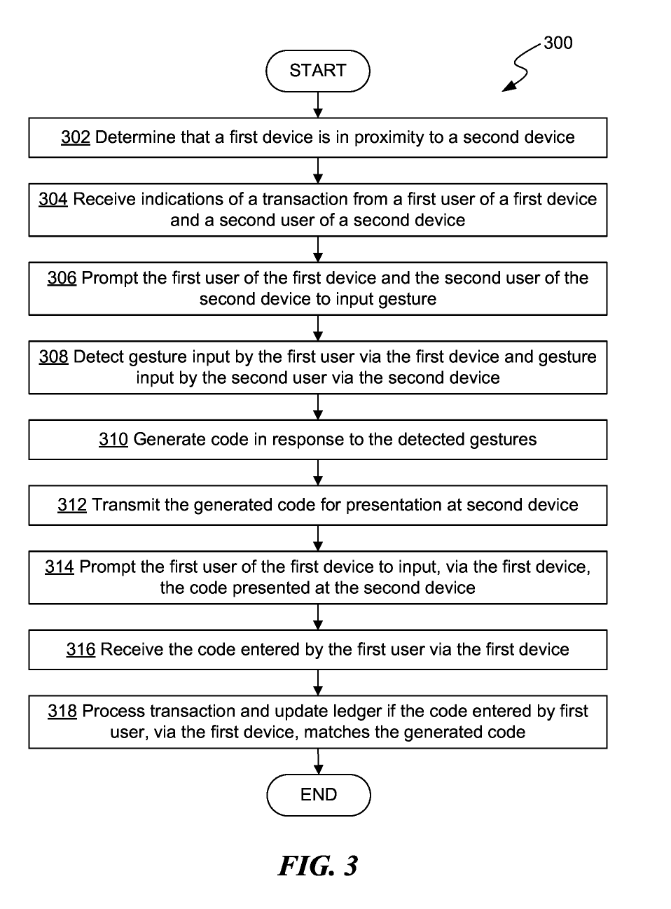

FIG. 3 shows a flowchart of an example process 300 for gesture-based transaction between mobile devices. This example gesture-based process is also referred to herein as a “handshake” method. The example process 300 of FIG. 3 is described in the context of users of mobile communications devices that are in proximity to each other. In this example, a first user 103a of a first device 102a is in proximity to a second user 103b of a second device 102b. Both devices 102a and 102b have an application (e.g., a thin client) installed thereon and are in communication with a remote transaction service 104, for example, via one or more networks 110. In the example scenario the first user 103a is transferring funds to the second user 103b through the use of the gesture-based transaction method. Accordingly, the first user 103a may be referred to as “sender” and the second user 103b may be referred to as a “receiver.” The example, process 300 enables users of mobile devices to quickly and securely perform transactions and is beneficial over existing systems because it does not require the users to exchange any personally identifiable information (PII) such as an email address, phone number, account number, username, etc.

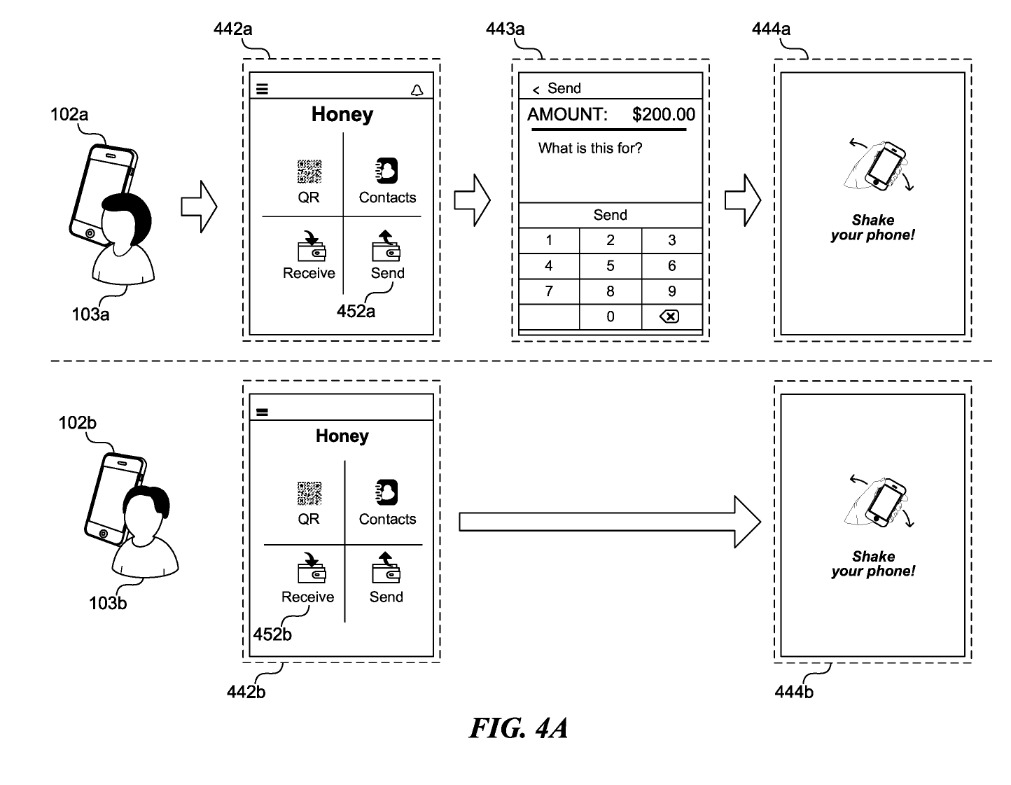

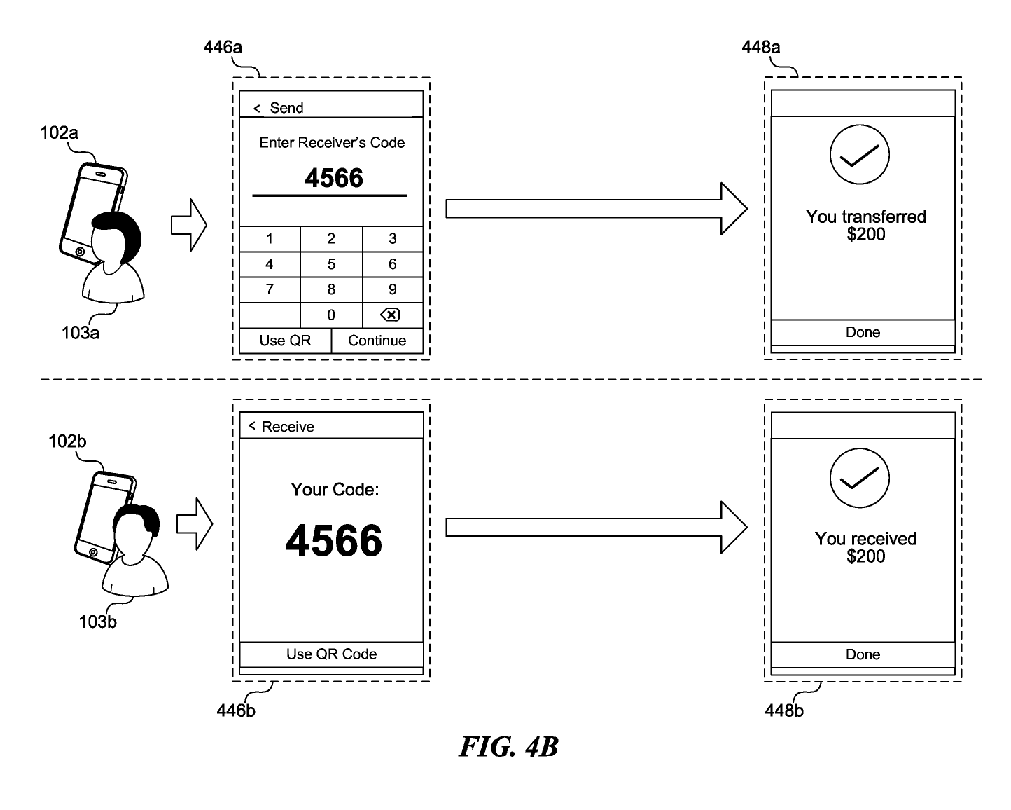

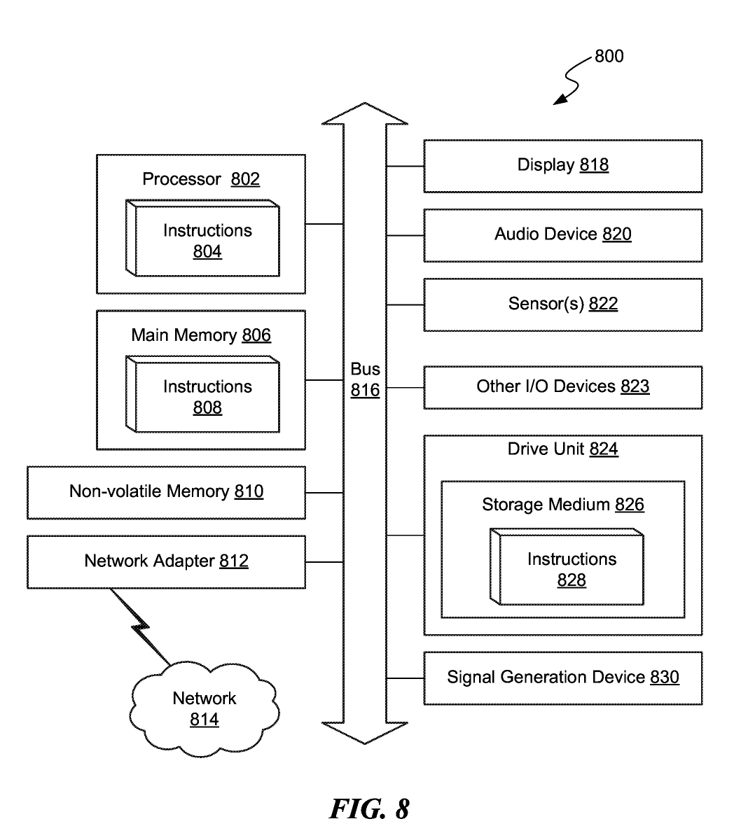

One or more steps of the example process 300 may be performed by any one or more of the components of the example network computing environment 100 described with respect to FIG. 1. For illustrative clarity, the example process 300 is described as being performed by a remote transaction service 104 that is in communication, via a computer network 110, with the first device 102a and the second device 102b. A person having ordinary skill will recognize that certain steps of the described process 300 may similarly be performed locally at the devices 102a-b and/or at any other devices along a path of communication between the transaction service 104 and the devices 102a-b. Again for illustrative purposes, the example process 300 is described with respect to the example user interface (GUI) screen captures of FIGS. 4A-4B. As mentioned, the GUI depicted in FIGS. 4A-4B is an example and is not to be construed as limiting. Other embodiments may involve a differently arranged GUI or no GUI at all (e.g., in the case of a voice-based system). The process 300 depicted in FIG. 3 may be represented in instructions stored in memory that are then executed by a processing unit associated with any of the aforementioned devices, for example as described with respect to the processing system 800 of FIG. 8. The process 300 described with respect to FIG. 3 is an example provided for illustrative purposes and is not to be construed as limiting. Other processes may include more or fewer steps than depicted while remaining within the scope of the present disclosure. Further, the steps depicted in example process 300 may be performed in a different order than is shown.

The example process 300 begins at step 302 with determining that the first device 102a is in proximity to the second device 102b. The term “in proximity” in this context means that the devices 102a-b are relatively near to each other in the physical environment. What qualifies as relatively near may vary depending on context and certain implementation requirements. For example, in some embodiments, the term “in proximity” can mean that the devices 102a-b are within the same building, within the same room, within a particular threshold distance (e.g., 1 meter, 10 meters, 100 meters, etc.), etc. The step of determining that the first device 102a is in proximity to the second device 102b can be performed using any known or yet to be discovered techniques for location and/or proximity detection. For example, if the devices 102a-b are equipped with GPS receivers, the devices 102a0b may transmit global position coordinates to the transaction service 104 that then, using the coordinates, calculates a distance between the devices 102a-b. In another embodiment, any one or more of the devices 102a-b may utilize internal proximity sensors to detect that the other device is in proximity. In another embodiment, the devices 102a-b may utilize a direct communication link (e.g., Bluetooth) to relay relative position information.

The example process 300 continues at step 304 with receiving, by the transaction service 104, via a network 110, an indication of a transaction from a first user 103a of the first device 102a (i.e., the sender) and a second user 103b of the second device 102b (i.e., the receiver). For example, the indications of the transaction may be in response to interaction by the users 103a-b with GUIs presented (e.g., via an application) at their respective devices 102a-b. As shown in screen capture 442a of FIG. 4A, a first user 103a can interact (e.g., through touching a touch-sensitive display) with an interactive graphical element 452a (e.g., a “send” button) presented via the display of the first device 102a. Conversely, as shown in screen capture 442b of FIG. 4A, a second user 103b can interact (e.g., through touching a touch-sensitive display) with an interactive graphical element 452b (e.g., a “receive” button) presented via the display of the second device 102b. Note that the indication of the transaction from the sender's side may include a configuration of a transaction amount (i.e., an amount of funds to transfer to the receiver). For example, in response to interacting with the send button shown at screen 442a, the first user 103a may be presented with screen 443a through which the first user 103a is prompted to enter a transaction amount and any other details regarding the transaction. For example, as shown in screen 443a, the first user 103a may be prompted to enter a note regarding the purpose of the transaction. As mentioned, the user interactions indicative of the transaction may be through means other than a GUI presented at the devices 102a-b. For example, in some embodiments, the user 103a-b may simply issue voice commands such as “send” or “receive” via their respective devices 102a-b to initiate a transaction. The devices 102a-b in this context may be voice-based automated assistant devices (e.g., Amazon Echo®).

At step 306, the transaction service 104 prompts the users 103a-b to input gestures via their respective devices 102a-b. For example, in an embodiment, a signal is sent by the transaction service 104, via the network 110, to the devices 102a-b to present a prompt to the users 103a-b to input the gestures. Screen captures 444a and 444b show examples of visual prompts presented to users 103a-b via devices 102a-b (respectively) to input gestures by shaking their respective devices. In another embodiment, an application at the user devices 102a-b may display the prompt in response to the user interaction at step 304 without any input by the transaction service 104. Again, the prompt to input the gesture need not be visual. In other embodiments, the transaction service 104 may cause devices 102a-b to output audible prompts such as “shake your phone.”

In some embodiments, steps 302, 304, and 306 are performed locally by applications at the respective devices 102a-b. In other words, the transaction service 104 may not be involved with initially determining that the devices 102a-b are in proximity at step 302, receiving the indication of the transaction at step 304, and/or prompting the users 103a-b to input the gestures at step 306. In such an embodiment, an applications at the devices 102a-b may detect that the devices are in proximity, for example, using any means described with respect to step 302. Provided that the devices 012a-b are in proximity, the applications may prompt the users to input the gesture in response to receiving an indication of the transaction (including a configured amount) from the first user 103a via the first device 102a. Information regarding the detected gestures may then be transmitted by the applications, via the network 110, to the remote transaction service 104, where the process then picks up at step 308. In such an embodiment, the information regarding the detected gestures transmitted by the applications may include timing information (e.g., time stamps) as well as location information (e.g., GPS coordinates of the devices 102a-b) that can then be utilized by the transaction service 104 to infer an intent (i.e., based on temporal and physical proximity) by the users 103a-b to complete a transaction.

At step 308, the transaction service 104 detects input of the gestures by the users 103a-b via their respective devices. As alluded to above, a “gesture” in this context may include any sort of motion-based input such as shaking the device 102a-b, moving the device 102a-b in a predefined motion pattern (e.g., circular motion), inputting a touch gesture via a touch screen of the device 102a-b (e.g., a drawn pattern), motioning with user's hand or finger, etc. In an embodiment, motion of a device 102a-b can be sensed using internal motions sensors such as individual accelerometers or integrated inertial measurement units (IMU). Sensor data gathered by such internal motions sensors can be transmitted to the transaction service 104 for processing to determine that it corresponds with a recognized gesture (e.g., a shaking gesture). Alternatively, the sensor data may be processed locally at the device 102a-b (e.g., using the application) to determine that the sensed motion corresponds with a recognized gesture. A signal can then be transmitted from the device 102a-b indicating that the recognized gesture has been input at the device 102a-b. Motion may be detected by other types of motions sensors as well. For example, in an embodiment, a camera at a device 102a-b (or associated device) may be configured to capture images of the users 103a-b. The captured images can then be processed using computer vision techniques to recognize and track the motion of various objects in the image. For example, a camera may be configured to track the motion of a user's hand or fingers and detect a gesture input based on the movement.

In some embodiments, feedback may be provided to the users 103a-b to indicate that their input gestures have been detected. Feedback (e.g., visual, audible, tactile, etc.) may be provided via the respective devices 102a-b of the users 103a-b after they input the gestures. For example, in response to shaking their device 102a-b, the transaction service 104 and/or application at the device 102a-b may cause the device 102a-b to vibrate so as to provide haptic feedback to the user 103a-b that a gesture (e.g., shaking) has been detected. Other type of feedback such as an audible tone output through speakers of the device 102a-b or a visual confirmation output through a display of the device 102a-b may also be provided.

In some embodiments, step 308 may involve the transaction service 104 actively listening for signals indicative of a particular type of gesture (e.g., shaking) input at any two devices 102a-b in proximity to each other. For example, consider a scenario in which two users 103a-b are in a crowded physical location filled with multiple other people (including other users having other devices). In such a scenario, without any other prior notification by the devices 102a-b of an impending transaction, the transaction service 104 may actively “listen” for signals received over the network 110 of a detected gesture (e.g., a shaking gesture) occurring at two devices 102a-b within a particular window of time (e.g., 10 seconds) and within a particular spatial proximity (e.g., 5 feet). With this information, the transaction service 104 may, in effect, infer that the user 103a of the first device 102a wishes to complete a transaction with a user 103b of the second device 102b.

At step 310, the transaction service 104 generates a code in response to successfully detecting the gestures at step 308. The generated code may be unique to the transaction that will be completed between the first user 103a and the second user 103b and as will be described required to complete the transaction.

In some embodiments, the generated code may be configured as a sequence of alphanumerical characters. For example, as shown in FIG. 4B, the code may be configured as a sequence of numbers. Alternatively, or in addition, the code may be configured as a visual symbol or set of symbols, an encoded graphic (e.g., a QR code or other type of bar code), an audible signal (e.g., a sequence of audible tones, an audio recording or reading of an alphanumeric code, etc.), or any other set of information that can uniquely correspond with the transaction to be completed.

In some embodiments, the code is generated only if gestures are detected at both the first device 102a and the second device 102b. In this sense, the detected gestures may indicate an intent by both the first user 103a and the second user 103b to proceed with a transaction. In some embodiments, generation of the code may depend on when the gestures are detected at each device 102a-b. For example, in some embodiments, signals received form the devices 102a-b that are indicative of the motion and/or detected gesture are time stamped. The transaction service 104 may be configured to compare time stamps associated with each signal and generate the code if a calculated duration between timestamps is below a specified duration threshold (e.g., 60 seconds). In some embodiments, the duration threshold is a static value (e.g., 60 seconds). In other embodiments, the threshold can be configured by a user such as the users 103a-b of devices 102a-b and/or an administrator user associated with the transaction service 104. In some embodiments, the duration threshold may dynamically change based on one or more variables. For example, a threshold duration within which to detect the gestures may depend on the types of devices 102a-b used, a calculated distance between the devices 102a-b, a transaction type (e.g., customer-to-vendor vs. user-to-user), a transaction amount, whether other devices are in proximity to the devices 102a-b, the type of network (e.g., trusted vs. untrusted) that the devices 102a-b are connected to, etc.

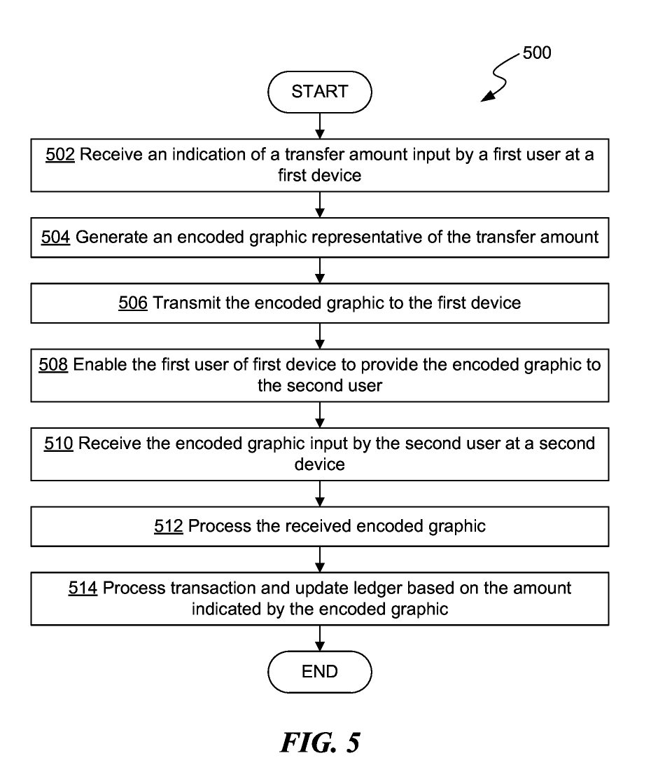

The generated code may be ephemeral in that the generated code may remain valid for only a limited period of time. In such an embodiment, if the transaction does not complete (e.g., according to the remaining steps of process 300) within the specified period of time, the code will expire. If the code expires before the transaction completes, the process 300 may restart, the transaction service 104 may generate a new code, or the process 300 may default to another type of process such as one based on an encoded graphic described with respect to FIG. 5. In some embodiments, the period of validity for a generated code is a static value (e.g., 60 seconds). In other embodiments, the period of validity for a generated code can be configured by a user such as the users 103a-b of devices 102a-b and/or an administrator user associated with the transaction service 104. In some embodiments, the period of validity for a generated code may dynamically change based on one or more variables. For example, the period of validity for a generated code may depend on the type of code generated, the types of devices 102a-b used, a calculated distance between the devices 102a-b, a transaction type (e.g., consumer-to-merchant vs. user-to-user), a transaction amount, whether other devices are in proximity to the devices 102a-b, the type of network (e.g., trusted vs. untrusted) that the devices 102a-b are connected to, etc.

Assuming a code is generated at step 310, example process continues at step 312 with transmitting the generated code for presentation at the second device 102b (i.e., the device of the receiver in the transaction). For example, as shown in FIG. 4B at screen 446b, the code (in this case a numerical code) can be displayed via a GUI at the second device 102b. Alternatively the code may be presented at the second device 102b via non-visual means. For example, the code may be audibly presented (e.g., though a text-to-voice process) via speakers at the second device 102b.

After the code is presented at the second device 102b, the example process continues at step 314 with prompting the first user 103a (i.e., the sender) to enter the code (as presented via the second device 102b) via the first device 102a. For example, as shown in FIG. 4B at screen 446a, a GUI displayed via the first device 102a is prompting the first user 103a to enter the code. Although not depicted in FIG. 4B, the prompt may also include an instruction directed at the first user 103a (i.e., the sender) to observe the code as presented via the second device 102b (i.e., the receiver's device) before entering.

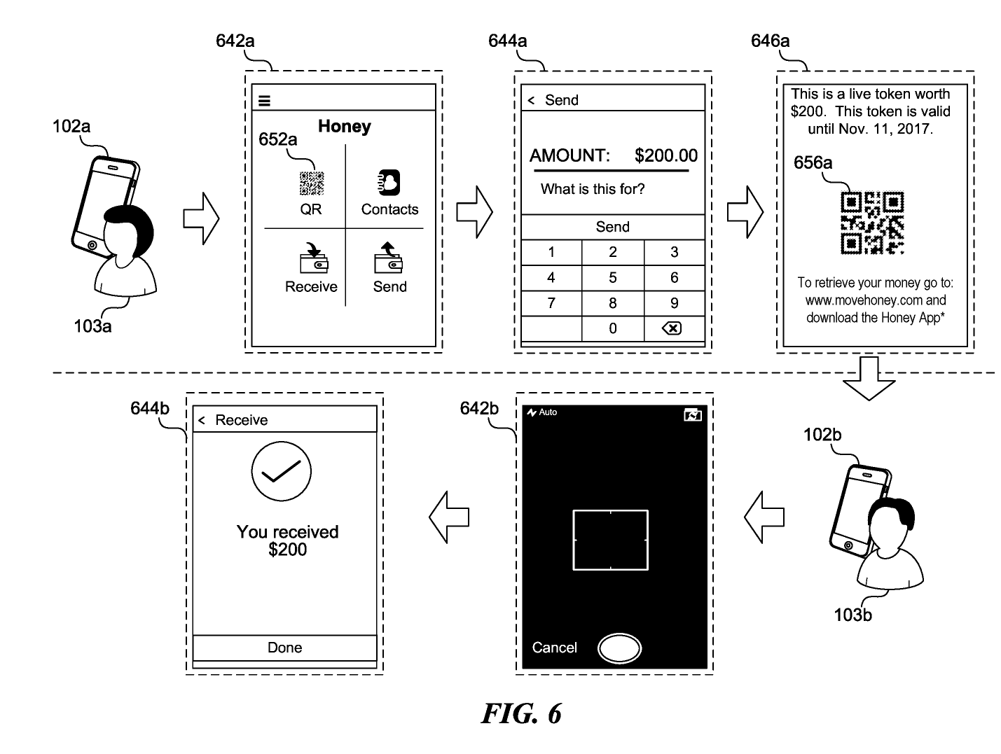

In the example depicted in FIG. 4B, the code is a sequence of numerical characters (“4566”). Accordingly, the GUI presented at the first device 102a may include an interactive mechanism for entering numerical characters. For example, screen 446a shows an interactive keypad through which the first user 103a can enter the numerical characters. The type of interactive mechanism will depend on the type of code. For example, if the code is presented as an encoded graphic (e.g., a QR code) via a display of the second device 102b, the prompt presented at the first device 102a may include an option to capture an image of the displayed graphic, for example, using an internal camera of the first device 102a. For example, the screen 446a depicted in FIG. 4B includes an option to “use QR.” In such an embodiment, selection of this option via screen 446a may bring up a camera interface (e.g., similar to as shown at screen 642b in FIG. 6) through which the first user 103a can capture an image of the graphic displayed at the second device 102b.

In some embodiments, the prompt at step 314 may instead be audibly presented to the first user 103a via speakers at the first device 102a. Further, in some embodiments, the first user 103a may be prompted to input the code using his or her voice, for example, by speaking into a microphone of the first device 102a. Similar to the gesture inputs, the received voice input form the first user 103a may be processed and interpreted locally at the first device 102a or may be transmitted, via the network 110, to the remote transaction service 104 for processing and interpretation.

The code (as entered by the first user 103a) is then transmitted, by the first device 102a, to the remote transaction service 104 where it is then received at step 316 and authenticated. Authentication by the transaction service 104 may include comparing the code as entered by the first user 103a (i.e., the sender) to the code (e.g., stored in memory) that was generated at step 310 and transmitted to the second device 102b (i.e., the receiver's device) and authenticating if the codes match. Again, the code generated at step 310 may be ephemeral, in which case successful authentication may require identifying such a match within the period of validity for the generated code.

In some embodiments, authentication at the transaction service 104 based on the code received at step 316 may involve additional steps. For example, the transaction service 104 may again verify (e.g., based on signals received from one or more of the devices 102a-b) that the devices 102a-b were still within threshold proximity at the time the first user 103a entered the code. As an added security measure, the transaction service 104 may require a two-step process to verify an intent by the first user 103a (i.e., the sender) to proceed with the transaction. For example, the transaction service 104 may transmit a prompt to the first user 103a to enter another code (e.g., a personal identification number or PIN) via the first device 102a to verify or to enter the same code or another code (e.g., the PIN) via a third device to verify. As another example, the transaction service 104 may require the first user to both enter the code via the GUI (e.g., as shown in FIG. 4B) and say the code (or some other code) via the speakers of the first device 102a. As another example, the transaction service 104 may require a biometric authentication by the first user 103a at the first device 102a in addition to the entered code. For example, if the first device 102a is equipped with a biometric input device (e.g., a thumbprint reader, retinal scanner, voice print identifier, etc.), the application at the first device 102a may require that the first user 103a authenticate entry of the code through a simultaneous or subsequent entry via the biometric input device before transmitting the entered code to the remote transaction service 104. In such an embodiment, the application at the first device 102a may be configured to receive a signal indicative of the biometric authentication from an operating system or other application at the first device 102a without accessing any PII (e.g., the thumbprint, retinal scan, or voice print recording) associated with the first user 103a.

Assuming that the code received at step 313 is authenticated, the transaction service 104 then proceeds at step 318 to process the transaction. In an embodiment, processing the transaction involves updating a ledger to reflect the deduction of the transaction amount from an account associated with the first user 103a (i.e., the sender) and an addition of the transaction amount to an account associated with the second user 103b (i.e., the receiver). As previously discussed, the ledger may be a centralized ledger associated with the transaction service 104, a centralized ledger associated with a third-party financial entity such as a bank, or a master ledger stored in a distributed database system such as a blockchain.

Once the transaction between the first user 103a and second user 103b is fully processed, the transaction service 104 may transmit a notification to the first device 102a and/or second device 102b confirming successful completion of the transaction. For example, FIG. 4B shows an example screen 448a presented at the first device 102a that notifies the first user 103a that they have successfully transferred $200 and a corresponding notification at the second device 102b (see e.g., screen 448b) that notifies the second user 103b that they have received $200.

Transaction with an Application at Only One Device

FIG. 5 shows a flowchart of an example process 500 for performing a transaction between users using a one-sided application. In other words, the example process 500 described with respect to FIG. 5 does not rely on both parties to the transaction having a corresponding device with an application installed. In the example process 500, a first user 103a having a first device 102a is seeking to transfer funds to a second user 103b. Accordingly, the first user 103a may be referred to as “sender” and the second user 103b may be referred to as a “receiver.” The first device 102a has an application (e.g., a thin client) installed thereon which is in communication with a remote transaction service 104, for example, via one or more networks 110. While the second user may have an associated second device 102b, the second device 102b does not necessarily have a corresponding application installed thereon, for example, as present in the example process 300 of FIG. 3. The example process 500 enables a user to quickly and efficiently perform a transaction with another user through the generation of an encoded graphic that acts as a live financial token. Again, the described process is beneficial over existing systems because it does not require the users to exchange any personally identifiable information (PII) such as an email address, phone number, account number, username, etc.

One or more steps of the example process 500 may be performed by any one or more of the components of the example networked computing environment 100 described with respect to FIG. 1. For illustrative clarity, the example process 500 is described as being performed by a remote transaction service 104 that is in communication, via a computer network 110, with the first device 102a and the second device 102b. A person having ordinary skill will recognize that certain steps of the described process 500 may similarly be performed locally at the devices 102a-b and/or at any other devices along a path of communication between the transaction service 104 and the devices 102a-b. Again for illustrative purposes, the example process 500 is described with respect to the example user interface (GUI) screen captures of FIG. 6. The GUI depicted in FIG. 6 is an example and is not to be construed as limiting. Other embodiments may involve a differently arranged GUI. The process 500 depicted in FIG. 5 may be represented in instructions stored in memory that are then executed by a processing unit associated with any of the aforementioned devices, for example as described with respect to the processing system 800 of FIG. 8. The process 500 described with respect to FIG. 5 is an example provided for illustrative purposes and is not to be construed as limiting. Other processes may include more or fewer steps than depicted while remaining within the scope of the present disclosure. Further, the steps depicted in example process 500 may be performed in a different order than is shown.

The example process 500 begins at step 502 with receiving, by the transaction service 104, via a network 110, an indication of a transaction from a first user 103a of the first device 102a (i.e., the sender). For example, the indication of the transaction may be in response to interaction by the first user 103a with GUI presented (e.g., via an application) at the first device 102a. As shown in screen capture 642a of FIG. 6, a first user 103a can interact (e.g., through touching a touch-sensitive display) with an interactive graphical element 652a to cause the generation of an encoded graphic such as a QR code to effectuate a transaction to a second user 103b that does not have the application installed at a second device 102b. Note that the indication of the transaction from the sender's side may include a configuration of a transaction amount (i.e., an amount of funds to transfer to a receiver). For example, in response to interacting with the “QR” button shown at screen 642a, the first user 103a may be presented with screen 644a through which the first user 103a is prompted to enter a transaction amount and any other details regarding the transaction. For example, as shown in screen 643a, the first user 103a may be prompted to enter a note regarding the purpose of the transaction. As previously mentioned, user interactions indicative of the transaction may be through means other than a GUI presented at the devices 102a-b. For example, in some embodiments, the first user 103a may simply issue a voice command such as “send” or “generate QR” via the first device 102a to initiate a transaction. The first device 102a in this context may be a voice-based automated assistant device (e.g., Amazon Echo®).

The example process 500 continues at step 504 with generating an encoded graphic representative of the transaction amount indicated by the first user 103a. In some embodiments, step 504 may include generating, by the transaction service 104, a private key (e.g., a unique string of alphanumeric characters) associated with the transaction amount indicated by the first user 103a and converting that private key into the encoded graphic. In this context, the private key is recognizable to the transaction service 104 to verify and refer to the indicated transaction. In an illustrative embodiment, the encoded graphic may include a QR code, other types of bar codes (e.g., a UPC barcode, an image or sequence of images, or any other type of visual element can be processed by a computing device, for example, using computer vision. The encoded graphic generated at step 504 may act as a live financial token that is redeemable one time by any other entity for the transaction amount. In other words, the encoded graphic can effectively act as a cash transfer from the first user 103a (sender) to a recipient that redeems the encoded graphic even if the recipient is not intended by the first user 103a.

In some embodiments, the encoded graphic may be generated at step 504 by a local application at the first device 102a instead of the transaction service 104. Note that to prevent fraudulent transactions, the application at the first user device may still be required to communicate with the transaction service 104, for example, to receive a private key that is then used to generate the encoded graphic.

At step 506, the transaction service 104 transmits the encoded graphic, via network 110, to the first device 102a of the first user 103a (i.e., the sender). For example, as shown at screen 646a in FIG. 6, the encoded graphic generated in response to the request by the first user 103a can be presented via a display of the first device 102a. In the example screen 646a, the encoded graphic is represented in the form of a QR code 656a and further includes an indication of a value of the token (i.e., the transaction amount) and instructions for redeeming the token for the indicated transaction amount.

At step 508, first user 103a of the first device 102a provides the encoded graphic to another person (i.e., a second user 103b) through any available mode of conveyance. For example, the encoded graphic can be transmitted, via a network 110, to a second user 103b of a second device 102b via email, SMS messaging, etc. Alternatively, if the first user 103a is in proximity to the second user 103b, the first user 103a may simply show the second user 103b the encoded graphic via the display of the first device 102a. The second user 103b may then take a picture of the display screen of the first device 102a using a second device 102b to capture the encoded graphic. For example, screen 642b in FIG. 6 shows an example interface of a camera application at a second device 102b of the second user 103b. Alternatively, the first user 103a may print out a hard copy of the encoded graphic and provide the hard copy to the second user 103b. The second user 103b may then take a picture of the hard copy using a second device 102b to capture the encoded graphic.

The encoded graphic provided to a second user 103b (i.e., a receiver) can include instructions for redeeming the token for the transaction amount. For example, the encoded graphic may include a hard-coded URL with instructions such as “go to this website to redeem this token.” The instructions for redeeming the transaction amount can further include a prompt to download the application associated with the transaction service 104 to facilitate the redemption. For example, the hard-coded URL may automatically redirect to an appropriate app store such as the Apple® App Store to download the application. Once the application is downloaded to the second device 102b of the second user 103b, the application may prompt the second user 103b to access the token including the encoded graphic stored at the second device 102b. For example, the downloaded application may request access to the second user's 103b photos, text messages, emails, etc. in order to retrieve the token including the encoded graphic. Once the token including the encoded graphic is retrieved, the application may initiate the redemption process, for example, by transmitting the encoded graphic or some (other information based on processing of the encoded graphic) to the transaction service 104.

Alternatively, or in addition, the application may redirect the second user 103b to another party that is willing to accept the token with the encoded graphic in exchange for cash or some other valuable consideration. For example, the downloaded application may present a listing of other parties (e.g., individuals or vendors) in proximity to the second user that have indicated a willingness to exchange such a token for cash or some other valuable consideration. The listing of other parties willing to accept the token may be presented via a map with the location of each party indicated in the map.

Example process 500 continues at step 510 with receiving, by the transaction service 104, via a network 110, the encoded graphic (or some other information based on processing of the encoded graphic). For example, in response to detecting a request by the second user 103b to redeem the token including the encoded graphic, the application at the second device 102b may transmit the encoded graphic to the transaction service 104 for processing. Alternatively, or in addition, the application at the second device 102b may process the encoded graphic and transmit a signal based on the processing to the transaction service 104.

At step 512, the transaction service 104 processes the received encoded graphic (or some other information based on processing of the encoded graphic) and at step 514 processes the transaction. Processing the received encoded graphic may include verifying, by the transaction service 104, that the encoded graphic is valid and associated with an account of the first user 103a before processing the transaction. Similar to the example process 300, processing of the transaction at step 514 may include updating a ledger to reflect the deduction of the transaction amount from an account associated with the first user 103a (i.e., the sender) and an addition of the transaction amount to an account associated with the second user 103b (i.e., the receiver). As previously discussed, the ledger may be a centralized ledger associated with the transaction service 104, a centralized ledger associated with a third-party financial entity such as a bank, or a master ledger stored in a distributed database system such as a blockchain.

As previously discussed, the generated token with the encoded graphic can be intended to operate similar to cash in that it is fully redeemable by any recipient whether intended by the first user 103a (i.e., the sender) or not. Accordingly, process 500 generally will not include any additional step during the redemption sequence, for example, to seek verification from the first user 103a. However, depending on the particular implementation, such a step can be included. For example, in an embodiment, in response to receiving the encoded graphic from the second user 103b, the transaction service 104 may prompt the first user 103a to verify the redemption, for example, by entering a code (e.g., a PIN), a biometric input, or some other indication of assent to the transaction via the first device 102a.

Once the transaction is fully processed, the transaction service 104 may transmit a notification to the first device 102a and/or second device 102b confirming successful completion of the transaction. For example, FIG. 6 shows an example screen 644b presented at the second device 102b that notifies the second user 103b (i.e., the receiver) that they have successfully have received $200.

The example process 500 described above can similarly be applied to process transactions in the opposite direction. For example, in an embodiment, a first user 103a can cause the transaction service 104 to generate and return an encoded graphic such as a QR code that is indicative of a transaction amount owed to the first user 103a. Consider, for example, a scenario in which the first user 103a is a vendor selling goods. The vendor in this scenario can associate the encoded graphic with the vendor's account and a particular good for sale. The graphic may be encoded based on the amount due to the merchant as well as other information such as an identifier associated with the product or service offered (e.g., a serial number or stocking number), the vendor's name, and any other relevant information. The vendor can pre-print the encoded graphic and affix the printed graphic to a packaging of the good (e.g., as a label), in a booklet of printed graphics at a check-out station, or may display the encoded graphic via a point-of-sale (POS) device (e.g., in response to scanning a separate UPC bar code printed on the product packaging). When a customer wishes to purchase the good offered by the vendor, the customer “redeems” the encoded graphic, for example, by taking a picture of the encoded graphic with a mobile communication device. In response to the redemption by the customer, a transaction amount associated with the encoded graphic is automatically transferred from the customer user's account to the vendor's account. In some embodiments, in response to capturing the encoded graphic (e.g., by taking a picture of it) a payment agreement message and option to confirm are presented to the customer via the customer's mobile communication device and/or the vendor's POS device. The customer then must agree or disagree with the payment details. If the customer agrees, transaction is processed and a confirmation is displayed via the customer's mobile communication device and/or via the vendor's POS device. If the customer disagrees with the payment details, the transaction can be cancelled

The vendor may elect to receive payment for goods and services using the peer-to-peer model of the transaction service 104 as part of a subscription fee that would include additional value to the vendor instead of paying a percentage tied to the transaction (e.g., in the case of credit card transactions). Value provided to the vendor as part of the subscription service might include access to data, a marketing agreement, points, or barter.

### Cash Fulfillment

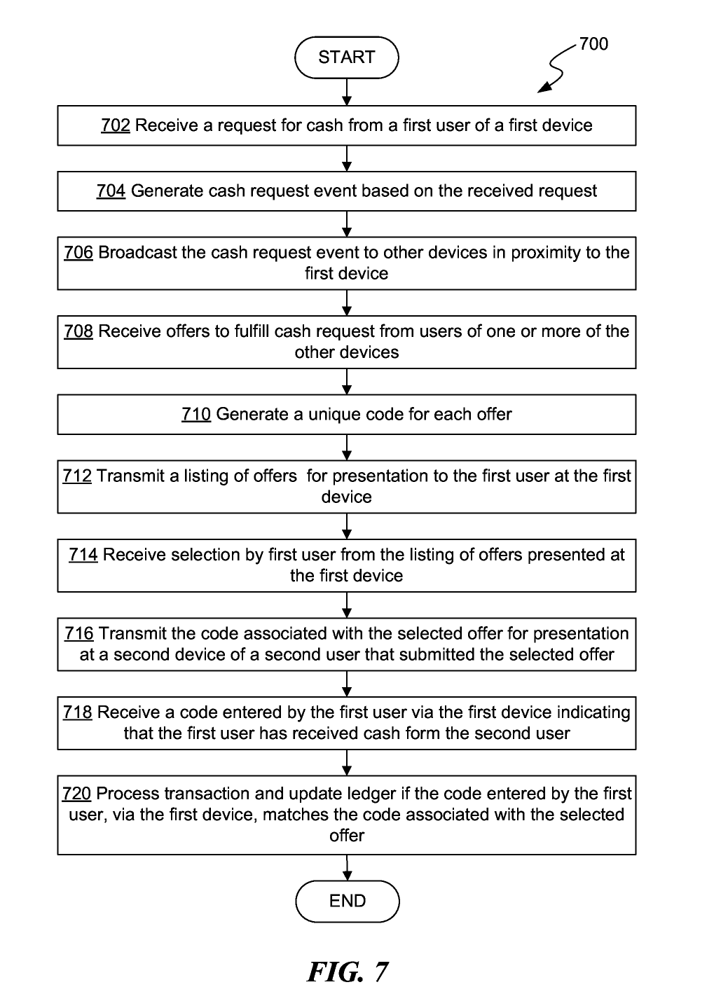

FIG. 7 shows a flowchart of an example process 700 for fulfilling cash requests between users. In other words, the example process 700 represents an effective way for users of the application (and associated transaction service 104) to become virtual ATM machines for other users in a local area. For example, in an embodiment, a first user 103a that needs cash can open an application at a first device 102a, select the appropriate option to request the cash and enter a desired amount (e.g., $20). Other users in proximity to the first user 103a may then submit bids to fulfill the first user's 103a cash request.

Then, first user 103a selects a desired bid from a listing of received bids, and a second user 103b who offered the desired bid provides cash in the requested amount to the first user 103a, for example, in exchange for an agreed upon amount or fee. In other words, the first user 103a may be charged a fee by the second user 103b for fulfilling the cash request. The cash amount plus the agreed upon fee will then be transferred to an account associated with the second user 103b (i.e., the successful bidder) and deducted from an account associated with the first user 103a (i.e., the user requesting the cash). In this context, the first user 103a may be referred to as “requestor” and/or “receiver,” the other users may be referred to as “bidders” and/or “offerors,” and a second user 103b selected from the set of other offering users to fulfill the request may be referred to as a “fulfiller” and/or “sender.” The example process 700 enables a user to quickly and efficiently receive cash from other users nearby without requiring the users to exchange personally identifiable information (PII) such as an email address, phone number, account number, username, etc.

One or more steps of the example process 700 may be performed by any one or more of the components of the example networked computing environment 100 described with respect to FIG. 1. For illustrative clarity, the example process 700 is described as being performed by a remote transaction service 104 that is in communication, via a computer network 110, with a first device 102a and a second device 102b. A person having ordinary skill will recognize that certain steps of the described process 500 may similarly be performed locally at the devices 102a-b and/or at any other devices along a path of communication between the transaction service 104 and the devices 102a-b. The example process 700 depicted in FIG. 7 may be represented in instructions stored in memory that are then executed by a processing unit associated with any of the aforementioned devices, for example as described with respect to the processing system 800 of FIG. 8. The process 700 described with respect to FIG. 7 is an example provided for illustrative purposes and is not to be construed as limiting. Other processes may include more or fewer steps than depicted while remaining within the scope of the present disclosure. Further, the steps depicted in example process 700 may be performed in a different order than is shown.

Example process 700 begins at step 702 with receiving, by the transaction service 104, via a network 110, a request for cash from a first user 103a of a first device 102a (i.e., the requestor). The request for cash may be initiated in response to an interaction by the first user 103a with a GUI presented (e.g., via an application) at the first device 102a. For example, the first user 103a may interact with a “request cash” button in a GUI presented at the first device 102a. The request for cash by the first user 103a will also include an indication of an amount of cash requested (e.g., $20). For example, in response to interacting with a “request cash” button, the first user 103a may be presented with an interactive element such as a keypad through which to enter a requested amount of cash. As previously mentioned, user interactions with a device may be through means other than a GUI. For example, in some embodiments, the user 103a may request cash by simply issuing a voice command such as “request $20 cash” via the first device 102a.

In response to receiving the cash request from the first user 103a, the transaction service 104 generates a cash request event at step 704 and at step 706 broadcasts the cash request event to other devices in proximity to the first device 102a. The term “in proximity” as well as certain techniques for determining the relative locations of devices to determine if they are in proximity to each other is described with respect to step 302 of example process 300. In some embodiments, the transaction service 104 may maintain location awareness of at least some of the devices that have a corresponding application installed thereon. Alternatively, users of other devices may proactively opt in as potential bidders and periodically transmit their location and an indication of their availability to the transaction service 104 in order to be considered for cash requests. In any case, the transaction service 104 may maintain a database of locations of other devices that are associated with other users that may potentially fulfill the cash request.

In some embodiments, in response to receiving the cash request from a first user 103a of a first device 102a, the transaction service 104 may query a database of location information and retrieve a listing of multiple devices within a threshold distance (e.g., 1 mile) to a location of the first device 102a. The threshold distance used for the query may be a static value (e.g., 1 mile) set by the transaction service 104. Alternatively, or in addition, the threshold distance may be based on a preference of the first user 103a received with the cash request. For example, the first user 103a may configure the cash request to only receive offers within 1 mile. Alternatively, or in addition, the threshold distance may dynamically change based on one or more variables. For example, a threshold distance may depend on an amount of cash requested. Transaction service 104 may also query a database to return a particular number of other devices (e.g., 100 device) that are nearest the first device regardless of their distance.

The transaction service 104 can transmit the cash request event to the other devices through any means of communication. For example, the transaction service 104 may transmit notifications via email, SMS text notification, and/or to an application installed at a device.

Users of devices receiving the broadcast cash request event can elect to “bid” on the request with offers to fulfill the cash request. For example, users of the other devices can bid on cash request events by interacting with a GUI presented (e.g., via an application) at their respective devices to enter offers to fulfill the cash request. Entered offers are then transmitted by the respective devices, via network 110, where they are then received by the transaction service 104 at step 708.

Example process 700 continues at step 710 with generating, by the transaction service 104, unique codes for each of the one or more received offers to fulfill the cash request. The codes generated at step 710 may be unique in the sense that they uniquely correspond with a potential transaction between the first user 103a requesting the cash and any one of the other users offering to fulfill the cash request. In some embodiments, the generated code may be configured as a sequence of alphanumerical characters. Alternatively, or in addition, the code may be configured as a visual symbol or set of symbols, an encoded graphic (e.g., a QR code or other type of bar code) or any other set of information that can uniquely correspond with a potential transaction to be completed.

At step 712, the transaction service 104 transmits a listing of the received one or more offers to the first device 102a for presentation to the first user 103a. Each offer in the transmitted listing may include information regarding the distance to the offeror, a transaction fee associated with the offer (if applicable), a unique code associated with the offer, reviews associated with the offeror, or any other relevant information. In some embodiments, the listing of offers is initially presented at the first device 102a in order of associated transaction fee (from lowest to highest). The order in which the listing of offers is presented can also be configured by the first user 103a of the first device 102a.

The first user 103a (i.e., the requestor) can select one (or more) of the offers included in the listing, for example, through interacting with a display of the listing in a GUI presented at the first device 102a or by issuing a voice command. The offer selected by the first user 103a (the “selected offer”) is then transmitted by the first device 102a, via a network 110, where it is received, at step 714, by the transaction service 104.

In response to receiving the first user's 103a selection, the transaction service 104 identifies a user that submitted the selected offer, referred to in this example as the second user 103b, and transmits, at step 716, the unique code associated with the selected offer (i.e., one of the codes generated at step 710) to a second device 102b of the second user 103b along with a notification that the offer has been accepted.

One purpose of transmitting the unique code associated with the offer to the second device 102b of the second user 103b is to enable the first user 103a (i.e., the requestor) to correctly identify the second user 103b as the offeror of the selected offer. In other words, the first user 103a can identify the second user 103b as the offeror by observing the unique code as presented at the second device 102b. In some embodiments, the transaction service 104 may perform other steps to help the users 103a-b find each other. For example, in some embodiments, after receiving a selection, by the first user 103a of a particular offer, the transaction service 104 may transmit alert notices to the users 103a-b via their respective devices 102a-b to help the user's identify each other. In some embodiments, a location of the second user 103b may be indicated in a map presented at the first device 102a of the first user 103a and vice versa. In some embodiments, the transaction service 104 may cause an audible or visual alert at the respective devices 102a-b when the devices are within a certain distance to each other.

Once the users 103a-b have identified each other, the second user 102b provides cash in the amount requested to the first user 103a (in-person) in accordance with the offer. To confirm receipt of the cash from the second user 103b, the first user 103a enters the unique transaction code presented at the second device 102b via the first device 102a. For example, an alphanumeric code may be entered manually by the first user 103a via an interactive keypad in a GUI presented at the first device 102a. Alternatively, an encoded graphic may be entered by the first user 103a, for example, by capturing an image of the screen of the second device 102b using a camera associated with the first device 102a. Alternatively, the first user 103a may enter the code using their voice by speaking into a speaker of the first device 102a. In any case, the unique code entered by the first user 103a is transmitted by the first device 102a, via a network 110, where it is then received by the transaction service 104 at step 718.

Assuming that the code received at step 318 is authenticated (i.e., matches the unique code generated for the selected offer), the transaction service 104 then proceeds at step 720 to process the transaction. In an embodiment, processing the transaction involves updating a ledger to reflect the deduction of the transaction amount (i.e., cash amount plus any applicable fees) from an account associated with the first user 103a (i.e., the requestor or receiver) and an addition of the transaction amount (i.e., cash amount plus any applicable fees) to an account associated with the second user 103b (i.e., the fulfiller or sender). In some embodiments, a portion of the transaction fee paid by the first user 103a may instead be directed to an account associated with a provider or the transaction service 104 as a fee for utilizing the transaction service 104. As previously discussed, the ledger may be a centralized ledger associated with the transaction service 104, a centralized ledger associated with a third-party financial entity such as a bank, or a master ledger stored in a distributed database system such as a blockchain.

Once the transaction between the first user 103a and second user 103b is fully processed, the transaction service 104 may transmit a notification to the first device 102a and/or second device 102b confirming successful completion of the transaction. For example, the second user 103b that fulfilled the first user's 103a cash request may receive a notification at the second device 102b of an increase to their account balance corresponding to the amount of cash provided plus the associated transaction fee.

### Transactions Based on Common Contact Information

In some embodiments, transactions between users 103a-b may be enabled if the users 103a-b have each other's contact information stored at their respective devices 102a-b. For example, a first user 103a may select contact information of a second user 103b (e.g., phone number, email address, etc.) stored locally at a first device 102a. Similarly, the second user 103b may select contact information of the first user 103a (e.g., phone number, email address, etc.) stored locally at a second device 102b. Whereas existing systems would just require one user to have the other's contact information, this disclosed technique may require both users to have each other's contact information. A sender (e.g., the first user) would then configure an amount to transfer to the receiver (e.g., the second user). The transaction may then proceed, for example, as described with respect to process 300 of FIG. 3. In such an embodiment, the transaction service 104 may be further tasked with confirming that each party to the requested transaction appears in the other party's contact list. If the users 103a-b do not have each other's contact information, then the transaction process may revert to an option to invite each other (e.g., through exchanging contact information) to participate in the transaction.

### Example Processing System

FIG. 8 shows a block diagram illustrating an example of a processing system 800 in which at least some operations described herein can be implemented. Various components of the processing system 800 depicted in FIG. 8 may be included in a computing device utilized to perform one or more aspects of the user interaction technique described herein such as devices 102a-b or any computing devices associated with the remote transaction service 104.

The processing system 800 may include one or more central processing units (“processors”) 802, main memory 806, non-volatile memory 810, network adapter 812 (e.g., network interfaces), a display 818, an audio device 820, sensors 822, and other input/output devices 823, drive unit 824 including a storage medium 826, and signal generation device 830 that are communicatively connected to a bus 816. The bus 816 is illustrated as an abstraction that represents any one or more separate physical buses, point to point connections, or both connected by appropriate bridges, adapters, or controllers. The bus 816, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

In various embodiments, the processing system 800 operates as a standalone electronic device, although the processing system 800 may also be connected (e.g., wired or wirelessly) to other machines in any configuration capable of executing a set of instructions (sequential or otherwise) that specify actions to be taken by the processing system.

While the main memory 806, non-volatile memory 810, and storage medium 826 (also called a “machine-readable medium”) are shown to be a single medium, the term “machine-readable medium” and “storage medium” should be taken to include a single medium or multiple media (e.g., a centralized or distributed database, and/or associated caches and servers) that store one or more sets of instructions 828. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure may be implemented as part of an operating system or a specific application, component, program, object, module, or sequence of instructions referred to as “computer programs.” The computer programs typically comprise one or more instructions (e.g., instructions 804, 808, 828) set at various times in various memory and storage devices in a computer, and that, when read and executed by one or more processing units or processors 802, cause the processing system 800 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include recordable type media such as volatile and non-volatile memory devices 810, floppy and other removable disks, hard disk drives, optical disks (e.g., Compact Disk Read-Only Memory (CD ROMS), Digital Versatile Disks (DVDs)), and transmission type media such as digital and analog communication links.

The network adapter 812 enables the processing system 800 to mediate data in a network 814 with an entity that is external to the processing system 800 through any known and/or convenient communications protocol supported by the processing system 800 and the external entity. The network adapter 812 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 812 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including, for example, the access and operation rights of an object by an individual, a machine, and/or an application, and the circumstances under which the permission rights stand.

The display 818 may utilize liquid crystal display (LCD) technology, light-emitting diode (LED) technology, organic LED (OLED) technology, or any other display technology configured to produce a visual output to a user. The visual output may be in the form of graphics, text, icons, video, images, and any combination thereof (collectively termed “graphics”). In some embodiments, the visual output may correspond to interactive elements implemented as part of a graphical user interface (GUI).

In some embodiments, a display 818 may be configured as a user input device, for example, in the form of a touch-sensitive display system. A touch-sensitive display system may have a touch-sensitive surface and a sensor (or set of sensors) that accepts input from the user based on haptic and/or tactile contact. The touch-sensitive display system (along with any associated modules and/or sets of instructions 804, 808, 828) may detect contact (and any movement or breaking of the contact) on the touch screen and convert the detected contact into interaction with presented digital media content. In some embodiments, the contact may be converted into user interaction with GUI objects (e.g., interactive soft keys or other graphical interface mechanism) that are displayed on the display 818. In some embodiments, the display system may be configured to detect close proximity or near contact (e.g., ˜1 millimeter) (and any movement or breaking of the contact) between the screen of the display 818 and an object such as the user's finger. In an exemplary embodiment, a point of contact (or point of near contact) between a touch screen and the user corresponds to a finger of the user or some other object such as a stylus.

A touch-sensitive display system may be associated with a contact/motion module and/or sets of instructions 804, 808, 828 for detecting contact (or near contact) between the touch-sensitive screen and other objects. A contact/motion module may include various software components for performing various operations related to detection of contact, such as determining if contact has occurred, determining if there is movement of the contact, tracking the movement of the contact across display screen, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multi-touch”/multiple finger contacts). In some embodiments, the contact/motion module may be employed to detect contact via other touch-sensitive input devices not associated with a display such as a touch pad.

In some embodiments, the display 818 may be configured as a tactile output device. Such a display may include systems configured to provide haptic feedback to a user interacting with the device through the use of various types of tactile stimuli. For example, a haptic feedback display may output mechanical vibrations, ultrasonic vibrations, and or electrical signals to provide haptic feedback to a user via the otherwise smooth surface of the display 818.

In some embodiments, the display 818 may be configured as an augmented reality (AR) or virtual reality (VR) display. An AR display can deliver to a user a live direct or indirect view of the surrounding physical environment that is augmented (or supplemented) by computer-generated sensory inputs such as sound, video, graphics or GPS data. For example, visual outputs can be displayed to a user via a transparent display while the user is viewing the surrounding physical environment. Examples of AR display devices include handheld display devices such as smart phones and tablet devices, head mounted display devices (e.g., Microsoft HoloLens™, Google Glass™), virtual retinal display devices, heads up display (HUD) devices (e.g., in vehicles), and the like.

An audio device 820, including one or more speakers and/or microphones, may provide an audio interface between an electronic device implementing processing system 800 and the environment surrounding the electronic device, including a user. Audio circuitry associated with the audio device 820 may receive audio data from other components of the processing system 800, convert the audio data into an electrical signal, and transmit the electrical signal to one or more speakers associated with the audio device 820. The one or more speakers may convert the electrical signal to human-audible sound waves. Audio circuitry may also receive electrical signals converted by a microphone from sound waves. The audio circuitry may convert the received electrical signals to audio data and transmit the audio data to the other components of the processing system 800 for processing. In some embodiments, audio data may be retrieved from and/or transmitted to memory 806.

Sensors 822 may include optical sensors, proximity sensors, location/motion sensors, or any other types of sensing devices.

Optical sensors may implement any type of optical sensing technology such as a charge-coupled device (CCD) or complementary metal-oxide semiconductor (CMOS) phototransistors. An optical sensor receives light from the environment, projected through one or more lenses (the combination of optical sensor and lens herein referred to as a “camera” or “image capture device”) and converts the light to data representing an image. In conjunction with an imaging module and/or sets of instructions 804, 808, 828, the optical sensor may capture still images and/or video of the surrounding environment. In some embodiments, an electronic device may be configured with two or more cameras, to capture depth information (e.g., stereoscopic vision).

Proximity sensors may generally implement any type of remote sensing technology for proximity detection and range measurement such as radar, sonar, and light illuminated detection and ranging (LIDAR).

In some embodiments, an electronic device implementing computer vision techniques may be configured to perform such remote sensing operations using the optical sensors of a camera. For example, a computer vision module and/or set of instructions 804, 808, 828 may be configured to receive images (including video) of the surrounding environment from an image capture device, identify (and in some cases recognize objects) captured in the received images, and track the motion of the identified objects captured in the images.

Location and/or motion sensors may implement any type of technology for measuring and reporting the position, orientation, velocity, and acceleration of an electronic device. For example, motion sensors may include a combination of one or more gyroscopes and accelerometers. In some embodiments, such components are organized as inertial measurement units (IMU).

For location sensing, a global positioning system (GPS) receiver can be used to receive signals from GPS satellites in orbit around the Earth, calculate a distance to each of the GPS satellites (through the use of GPS software), and thereby pinpoint a current global position of an electronic device with the GPS receiver.

The processing system 800 may further include any other types of input and/or output devices 823 not discussed above. For example, input/output devices 823 may include user input peripherals such as keyboards, mice, touch pads, etc. Input devices 823 may also include output peripherals such as printers (including 3D printers).

As indicated above, the techniques introduced here may be implemented by, for example, programmable circuitry (e.g., one or more microprocessors), programmed with software and/or firmware, entirely in special-purpose hardwired (i.e., non-programmable) circuitry, or in a combination of such forms. Special-purpose circuitry can be in the form of, for example, one or more application-specific integrated circuits (ASICs), programmable logic devices (PLDs), field-programmable gate arrays (FPGAs), etc.

Note that any of the embodiments described above can be combined with another embodiment, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method for processing a transaction between users of devices without requiring an exchange of personally identifiable information (PII) between the users, the method comprising:
detecting, by a computer system, gesture inputs by a first user of a first device and a second user of a second device, the first device and second device in proximity to each other, the detected gestures indicative of a request by the first user and the second user to process the transaction;
generating, by the computer system, a code associated with the transaction in response to the detected gesture inputs;
transmitting, by the computer system, via a computer network, the generated code for presentation at the second device;
prompting, by the computer system, the first user of the first device to observe the code as presented at the second device and to enter the code via the first device;
receiving, by the computer system, via the computer network, a code as entered via the first device; and
processing, by the computer system, the transaction if the code as entered via the first device matches the code as presented via the second device.

2. The method of claim 1, wherein the gesture inputs are detected based on data received from motion sensors at the first device and/or second device.

3. The method of claim 1, wherein the gesture inputs include the first user shaking the first device and the second user shaking the second device.

4. The method of claim 1, wherein the gesture inputs include a first gesture input by the first user via the first device and a second gesture input by the second user via the second device, the method further comprising:
determining, by the computer system, a period of time between the first gesture input and the second gesture input;
wherein the code is generated if the determined period of time satisfies a threshold criterion.

5. The method of claim 1, further comprising:
determining, by the computer system, that the first device is in proximity to the second device based on data received from global positioning system (GPS) receivers at the first device and/or second device.

6. The method of claim 1, wherein the generated code includes any of an alphanumeric code or a Quick Response (QR) code.

7. The method of claim 1, wherein processing the transaction includes updating, by the computer system, a ledger associated with the first user and/or second user.

8. The method of claim 7, wherein the ledger is a master ledger stored in a distributed database system.

9. The method of claim 1, further comprising:
transmitting, by the computer system, via the computer network, notifications to the first device and/or second device in response to completing processing of the transaction.

10. The method of claim 1, wherein the computer system hosts a web service configured to communicate with applications installed at the first device and/or second device.

11. The method of claim 1, wherein the first device and/or second device are mobile communications devices with applications stored thereon for communicating with a web service hosted by the computer system.

12. The method of claim 1, wherein the transaction involves a transfer from a first account associated with the first user to a second account associated with the second user.

13. A mobile communications device comprising:
a touch-sensitive display;
a motion sensor configured for sensing a motion of the mobile communications device;
a wireless network interface configured for communication over a computer network;
a processing unit; and
a memory unit coupled to the processing unit, the memory unit having instructions stored thereon, which when executed by the processing unit, cause the mobile communications device to:
receive, via the touch-sensitive display, a first input by a first user indicative of a request to perform a transaction with a second user;
display, via the touch-sensitive display, a first prompt to the first user to shake the mobile communications device;
detect a shaking of the mobile communications device based on data received from the motion sensor;
transmit, via the wireless network interface, to a transaction service hosted at a remote computer system, information indicative of the request and the detected shaking of the mobile communications device;
display, via the touch-sensitive display, a second prompt to the first user to:
observe a code presented by the transaction service at a second device associated with the second user, the code received at the second device, via the computer network, from the transaction service in response to the transmitted information; and
input the observed code to the first device;
receive, via the touch-sensitive display, a second input including the code as observed by the first user at the second device;
transmit, via the wireless network interface, to the transaction service, the code included in the second input; and
receive, via the wireless network interface, a confirmation that the transaction service has successfully processed the transaction in response to receiving the code included in the second input.

14. The mobile communications device of claim 13, wherein the code displayed at the second device is any of alphanumeric code or an encoded graphic.

15. The mobile communications device of claim 13, wherein receiving the second input includes receiving the code based on a detected interaction by the first user with an interactive keypad in a graphical user interface (GUI) displayed by the touch-sensitive display.

16. The mobile communications device of claim 13, further comprising:
a microphone configured to capture audio; and
a camera configured to capture images;
wherein receiving the second input includes any of:
receiving a voice command including the code via the microphone; or
capturing an image of the code as displayed at the second device using a camera associated with the first device.

17. The mobile communications device of claim 13, wherein processing of the transaction by the transaction service includes updating a ledger to reflect a deduction of the transaction amount from a first account associated with the first user and an addition of the transaction amount to a second account associated with the second user.

18. The method of claim 17, wherein the ledger is a master ledger hosted at a plurality of network connected computing devices based on a blockchain architecture.

19. A non-transitory computer-readable medium installed at a first device, the non-transitory computer-readable medium having instructions stored thereon, which when executed by a processor of the first device, cause the first device to communicate, via a computer network, with a transaction service hosted at a remote computing system to facilitate processing of a transaction between a first user of the first device and a second user of a second device without requiring an exchange of personally identifiable information (PII) between the first user and the second user by:
receiving an indication of the transaction including a transaction amount based on a detected interaction by a first user;
transmit, via the computer network, the indication of the transaction to the transaction service hosted at the remote computer system;
prompt the first user to input a gesture by moving the first device;
detect input of the gesture based on data received from motion sensors associated with the mobile device;
transmit, via the computer network, an indication of the detected gesture to the transaction service hosted at the remote computer system;
prompt the first user to:
observe a code presented by the transaction service at the second device, the code received at the second device, via the computer network, from the transaction service in response to the transmission of the indication of the detected gesture; and
input the observed code to the first device;
receive input from the first user of the code in response to the prompt;
transmit, via the computer network, to the transaction service, the code as input by the first user to the first device; and
receive, via the computer network, a confirmation that the transaction service has successfully processed the transaction in response to receiving the code as input by the first user.

20. The non-transitory computer-readable medium of claim 19, wherein the code displayed at the second device is any of alphanumeric code or an encoded graphic.

21. The non-transitory computer-readable medium of claim 19, wherein the instructions are part of a downloaded mobile application associated with the transaction service.

22. The non-transitory computer-readable medium of claim 19, wherein receiving input from the first user of the code includes any of:
receiving the code via an interactive keypad presented in a graphical user interface at the first device;
receiving a voice command including the code via a microphone associated with the first device; or
capturing an image of the code as presented at the second device using a camera associated with the first device.

23. The non-transitory computer-readable medium of claim 19, wherein processing of the transaction by the transaction service includes updating a ledger to reflect a deduction of the transaction amount from a first account associated with the first user and an addition of the transaction amount to a second account associated with the second user.

24. The non-transitory computer-readable medium of claim 23, wherein the ledger is a master ledger stored in a distributed database system.

25. A method for processing a transaction between users of devices without requiring an exchange of personally identifiable information (PII) between the users, the method comprising:
receiving, by a computer system, via a computer network, an indication of a transaction amount input by a first user via a first device;
generating, by the computer system, an encoded graphic based on the transaction amount input by the first user;
transmitting, by the computer system, via the computer network, the encoded graphic to the first device;
wherein the encoded graphic is transferable to and redeemable by any other user, via the computer system, for the transaction amount.

26. The method of claim 25, wherein the encoded graphic is a QR code.

27. The method of claim 25, wherein generating the encoded graphic includes:
generating a private key associated with the transaction amount and an account of the first user; and
converting the private key into the encoded graphic.

28. The method of claim 25, further comprising:
receiving, by the computer system, a request to redeem the encoded graphic input by a second user via a second device;
receiving the encoded graphic input by the second user via the second device; and
processing, by the computer system, the transaction for the amount indicated by the encoded graphic.

29. The method of claim 28, wherein processing the transaction includes:
identifying a first account associated with the first user based on the encoded graphic; and
updating a ledger to reflect a deduction of the transaction amount from the first account associated with the first user and an addition of the transaction amount to a second account associated with the second user.

30. The method of claim 29, wherein the ledger is a master ledger hosted at a plurality of network connected computing devices based on a blockchain architecture.

31. The method of claim 28, wherein the encoded graphic is received by the second user from the first user in any of:
an electronic message received, via the computer network, at the second device, from the first device;
an image of a physical print out captured by a camera of the second device; or
an image of a screen of the first device captured by the camera of the second device.

32. The method of claim 28, further comprising:
prompting the second user to download an application to the second device in response to receiving the request to redeem the encoded graphic;
wherein the application is configured to capture and transmit the encoded graphic, via the computer network, to the computer system for processing.

33. A method for facilitating a cash fulfillment transaction between users of devices without requiring an exchange of personally identifiable information (PII) between the users, the method comprising:
receiving, by a computer system, via a computer network, a request for cash by a first user via a first device;
generating, by the computer system, a cash request event in response to receiving the request;
broadcasting, by the computer system, via the computer network, the cash request event to other devices in proximity to the first device;
receiving, by the computer system, via the computer network, one or more offers to fulfill the cash request from users of one or more of the other devices in proximity to the first device;
generating, by the computer system, a unique transaction code for each of the received one or more offers to fulfill the cash request;
transmitting, by the computer system, via the computer network, a listing of the one or more offers for presentation to the first user at the first device;
receiving, by the computer system, via the computer network, from the first device, a selection by the first user of a particular offer to fulfill the cash request of the one or more offers to fulfill the cash request;
transmitting, by the computer system, via the computer network, the unique transaction code associated with the particular offer for presentation at a second device associated with a second user that submitted the particular offer to fulfill the cash request;
receiving, by the computer system, via the computer network, a code as entered via the first device, the code as entered via the first device indicative that the first user has received the requested cash from the second user; and
processing, by the computer system, the transaction if the code as entered via the first device matches the unique transaction code associated with the particular offer to fulfill the cash request.

34. The method of claim 33, wherein processing the transaction includes:
updating a ledger to reflect a deduction of a transaction amount from the first account associated with the first user and an addition of the transaction amount to a second account associated with the second user.

35. The method of claim 34, wherein the ledger is a master ledger stored in a distributed database system.

36. The method of claim 34, wherein the transaction amount includes an amount of cash requested by the first user plus a transaction fee amount imposed by the second user to fulfill the cash request.

37. The method of claim 33, wherein each of the received one or more offers to fulfill the cash request includes a bid on a transaction fee amount.

38. The method of claim 33, wherein broadcasting the cash request event to other devices in proximity to the first device includes:
determining a location of the first device based on data received from a global positioning system (GPS) receiver at the first device;
querying a database of location information to identify one or more other devices that are within a particular distance to the first device; and
transmitting the cash request event to the identified one or more other devices.

39. The method of claim 33, further comprising:
transmitting, by the computer system, via the computer network, notifications to the first device and/or second device to assist the first user and second user in identifying each other.
